(19) United States
(12) Patent Application Publication
(10) Pub. No.: US 2016/0245380 A1
(43) Pub. Date: Aug. 25, 2016

(54) PULL AND / OR PUSH ROD

(71) Applicant: Roehm GmbH, Sontheim/Brenz (DE)

(72) Inventor: Stefan KEMPTER, Landensberg (DE)

(73) Assignee: Roehm GmbH, Sontheim/Brenz (DE)

(21) Appl. No.: 15/053,492

(22) Filed: Feb. 25, 2016

(30) Foreign Application Priority Data
Feb. 25, 2015 (DE) 10 2015 102 724.0

(51) Int. Cl. F16H 25/12; B25J 15/02

(52) U.S. Cl. CPC F16H 25/12; B25J 15/0273

(57) ABSTRACT

A pull and/or push rod which is adjustable along a rod longitudinal axis, with a cam for guiding a control member having a coil section which is at least partially spiral-shaped and comprises one or more slope portions.

This nonprovisional application claims priority under 35 U.S.C. §119(a) to German Patent Application No. 10 2015 102 724.0, which was filed in Germany on Feb. 25, 2015, and which is herein incorporated by reference.

### BACKGROUND OF THE INVENTION

1. Field of the Invention

The invention relates to a pull and/or push rod. Such machine parts are often used in clamping and gripping technology to perform an axial motion, i.e. a motion oriented along a longitudinal axis, in order to switch the relevant clamping or gripping device between a clamping configuration and a release configuration.

2. Description of the Background Art

A known process is to trigger the axial movement of the components by means of threaded joints between threaded rods or threaded hollow bars. This process is described for a release unit, for example in DE 10 2011 116 818 A1, wherein the axial movement of the release rod is realized by a screw mechanism of two interlocking trapezoidal threads. These threaded connections have the disadvantage that the external threaded hollow bar often tilts because of the large prevailing play. The tilting is also caused because depending on the position of the threaded nut, the thread flanks are engaged with each other at different degrees, which means that possibly only minor thread engagement is present. Small thread engagement in cooperation with large prevailing play in the overall design can lead to an unwanted blocking of the system.

### SUMMARY OF THE INVENTION

It is therefore an object of the present invention to provide a pull and/or push rod which overcomes the disadvantages mentioned above.

This object is achieved in an exemplary embodiment by a pull and/or push rod which is adjustable along a rod longitudinal axis and which comprises a cam for guiding a control member. The cam comprises a coil section that is at least partially spiral and has one or more slope portions.

Thus, along the rod longitudinal axis of the pull and/or push rod, instead of a thread, a cam is formed which routinely includes a guide groove. The width of the guide groove or of the coil section of the cam is configured much wider than the threads of a trapezoidal thread, whereby when using a cam, a tilting of the elements engaging into the cam is virtually impossible. Further, a cam has the particular feature that it does not have to be shaped like a screw with threads having a constant pitch, but instead may also comprise slope portions having different gradients.

The cam can comprises at least one idle stroke section which is adjacent to the coil section and substantially radially extends to the rod longitudinal axis. Within the idle stroke section, a control member slides such in the cam of the pull and/or push rod that these experience no axial displacement.

This has the advantage that the pull and/or push rod can be fixed in its axial position when a control member is within the idle stroke section.

To manufacture the pull and/or push rod in a particularly simple manner, it has proven to be preferable when the cam is formed on an outer periphery of the pull and/or push rod. Preferably, the pull and/or push rod is additionally coated with a friction-reducing coating. In order to create a low-abrasion overall system, a DLC 4000 coating (DLC=Diamond-Like-Carbon; hard coating based on carbon) for the pull and/or push rod is conceivable. Further, the pull and/or push rod can be hardened, wherein the sliding surfaces of the cam are subsequently ground.

An embodiment provides that the pull and/or push rod is at least partially formed as a hollow rod and that the cam is formed in an inner periphery of the hollow rod. This has the advantage that the outside of the pull and/or push rod is available as a sliding surface within a housing, wherein the outer contour is also designed with a non-circular shape to provide an anti-rotation safeguard for the pull and/or push rod. The outer surface may hereby also be grafted or coated with materials having special sliding properties.

In order to rotationally drive the pull and/or push rod in a simple manner, it has proven to be useful when an extension of a non-circular cross-section or an inner receptacle of a non-circular cross-section is provided.

Further, a rotatable cap and/or a thrust bearing arranged on the pull and/or push rod on the side facing away from the extension or the inner receptacle is useful for decoupling rotational movements.

One potential application for the pull and/or push rod is in an electrical release unit.

The electrical release unit provides a pull and/or push rod according to the invention, and an electric motor which is at least indirectly rotationally coupled with the pull and/or push rod. Furthermore, the electrical release unit has a control member at least axially fixed in a housing, which engages in the cam of the pull and/or push rod for the axial adjustment of the pull and/or push rod between a clamping position and a release position. This electrical releasing unit, too, has the advantage that a tool clamping system-actuating release bar, which is thereby switched between a clamping position and a release position, is not formed with a threaded joint, but with an axially formed cam and with a control member engaging in the cam.

To ensure safe shifting between the two positions, it has proven to be particularly useful if the control member is formed as a control pin or as a cam. The prevailing rotational symmetry of the control member thereby allows for a simple sliding of the control member within the cam or within the guide groove.

In order to exercise a high torque to the pull and/or push rod, it has proven advantageous if the output of the electric motor is associated with an eccentric gear, which is at least indirectly rotationally coupled with the pull and/or push rod. In this context, a rear drive-free harmonic drive has been found particularly advantageous, which can provide a relatively large gear reduction in order to achieve high torque. A reduction between 1:60 and 1:40 has proven to be preferred, more preferably a reduction of 1:50.

In addition, it has proven to be useful if a driving flange is connected with a drive spindle of the electric motor, which comprises an axially extending drive collar. This drive collar can be coupled with other rotationally driven components.

For a simple transmission of the rotational movement, it has proven to be advantageous when the drive collar is associated with a driving flange having a non-circular cross-section for rotationally driving the pull and/or push rod.

In order to be able to monitor the axial position of the pull and/or push rod, it has proven to be preferable if the drive collar is non-rotatably coupled to a sensor sleeve having a sensor target which is eccentrically arranged relative to the rod longitudinal axis or formed with a circumferential pitch. It is advantageous in this case, if the sensor target is associated with a distance sensor, wherein the distance of the distance sensor to the sensor target is formed proportional to the axial position of the pull and/or push rod within the housing.

In order to be able to adjust the pull and/or push rod axially in a simple manner and in order to lose the least possible force during adjustment, it has proven advantageous if a slide bearing and/or a slide bush is arranged in the housing coaxially to the rod longitudinal axis.

A further advantageous application of the pull and/or push rod according to the invention is its use in an electrical separating device. This device is characterized in that it is formed with a pull and/or push rod which is guided non-rotationally but axially displaceable in a housing, and associated with a separating finger. Further, an electric motor is provided which is at least indirectly non-rotatably coupled to an actuating element, as well as a control member arranged on the actuating element, which engages in the cam for the axial adjustment of the pull and/or push rod between a separating position and an open position. Also in separating devices, no tilting of threaded joints occurs which could lead to a blockage or to damage to the separating device.

The separating position is the configuration of the separating device in which a single component (e.g. a magazined workpiece) is separated from further components (further magazined workpieces). The open position is the configuration of the separating device in which the components may pass through the separating device unseparated (non-isolated) from one another. This position is also often referred to as neutral because the workpieces can escape unhindered from the magazine.

In order to avoid damage to the separating device, it has proven to be preferable if in the pull and/or push rod a resilient element or a spring or a spring package is arranged for damping axial forces acting on the separating finger.

A further application of the inventive pull and/or push rod relates to its use in an electrical gripping device. This is characterized in that it has gripper base jaws which are guided in gripper grooves radially designed to the gripper longitudinal axis, and are adjustable. Via splines which extend in a sloped manner to the gripper longitudinal axis, the gripper base jaws interact with an axially adjustable wedge hook or wedge cone which according to the present invention is connected to a pull and/or push rod. Furthermore, an electric motor is at least indirectly non-rotatably coupled with an actuating element at which a control member is arranged, which engages in the cam for the axial adjustment of the pull and/or push rod between an open position, a clamping position and a closed position. The clamping position is located between the open position and the closed position and its position depends on the respective application of the gripping device.

To prevent damage to the gripper base jaws or the electric gripper device, it has proven advantageous if on the pull and/or push rod, a resilient element or a spring or a spring package is arranged for damping forces that radially act on the gripper base jaws.

It has been found preferable when top jaws for the releasable attachment to the gripper base jaws are provided, which are designed with radially inward gripper surfaces for external gripping of workpieces and/or with radially outward gripper surfaces for an internal gripping of workpieces. The top jaws can thereby have a shape that is adapted to the gripping workpiece so that this can be safely and securely gripped externally or internally.

Another application of the inventive pull and/or push rod relates to its use in an electric parallel gripper.

The electrical parallel gripper is hereby to be equipped with at least two gripper arms of which at least one can be actuated with a pull and/or push rod according to the present invention. Further provided is an electric motor which is at least indirectly non-rotatably coupled with an actuating element. At the possibly multi-part actuating element, a number of control members are arranged that, if necessary, may correspond to the number of pull and/or push rods which engage in the cam for axial displacement between a closed position and an open position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a to 1e illustrate an embodiment of the inventive pull and/or push rod,

FIGS. 2a and 2b illustrate an axial positioning system with a pull and/or push rod according to FIGS. 1a to 1e,

FIGS. 3a to 3e illustrate an embodiment of the inventive pull and/or push rod,

FIGS. 4a and 4b illustrate an axial positioning system with a pull and/or push rod in accordance to FIGS. 3a to 3e with a control member formed as a control pin,

FIGS. 5a and 5b illustrate the system of FIGS. 4a and 4b with a control member formed as a control ball,

FIGS. 6a to 6e illustrates an embodiment according to the inventive pull and/or push rod,

FIGS. 7a to 7e illustrates an embodiment of the inventive pull and/or push rod,

FIGS. 8a to 8e illustrates an embodiment of the pull and/or push rod having a cam formed as a spiral groove,

FIGS. 9a and 9b illustrate an axial positioning system with a pull and/or push rod according to FIGS. 8a to 8e,

FIG. 10 illustrates a longitudinal cross-section through an electrical release unit,

FIG. 11 illustrates the release unit of FIG. 10 in a partially sectioned, perspective view in the clamping position,

FIG. 12 illustrates the electrical release unit of FIGS. 10 and 11 in the release position,

FIG. 13 illustrates a separating device shown in the open position in a perspective view, partly sectioned,

FIG. 14 illustrates a longitudinal section of the separating device in FIG. 13,

FIG. 15 illustrates the separating device of FIG. 13 in the separating position,

FIG. 16 illustrates a longitudinal cross-section through the separating device of FIG. 15,

FIG. 17 illustrates a gripping device, partly shown for internal gripping in the open position in a perspective view section,

FIG. 18 illustrates a longitudinal cross-section through the gripping device of FIG. 17,

FIG. 19 illustrates the gripping device of FIG. 17 in the closed position (the clamping position is between the open and the closed position) in a partly sectioned, perspective view,

FIG. 20 illustrates a longitudinal cross-section through the gripping device of FIG. 19,

FIG. 21 illustrates a longitudinal cross-section through a parallel gripper in the closed position,

FIG. 22 illustrates the parallel gripper of FIG. 21 in a partly sectioned, perspective view,

FIG. 23 illustrates a longitudinal section through the parallel gripper of FIG. 21 in the open position,

FIG. 24 illustrates the parallel gripper of FIG. 23 in a partly sectioned, perspective view,

FIG. 25 illustrates a perspective view of a sensor system for controlling the axial position of a Pull and/or push rod,

FIG. 26 illustrate a plan view of the sensor system of FIG. 25, and

FIG. 27 illustrate a front view of the sensor system according to FIG. 25.

### DETAILED DESCRIPTION

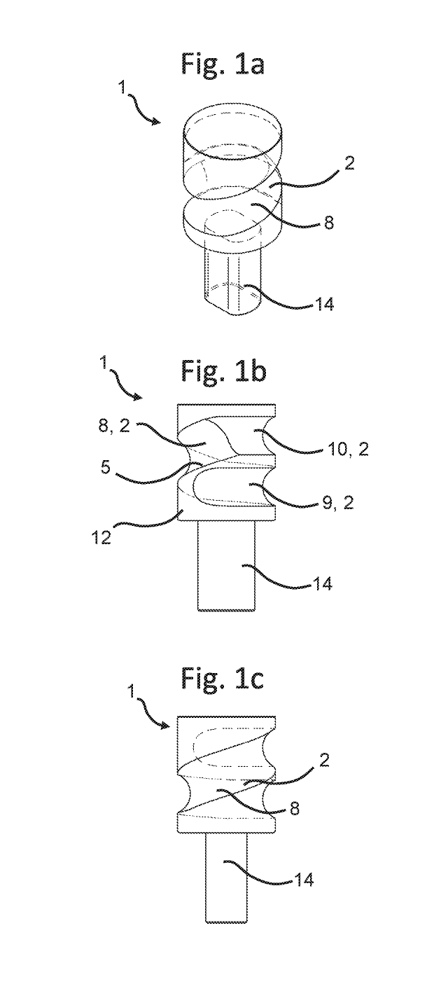

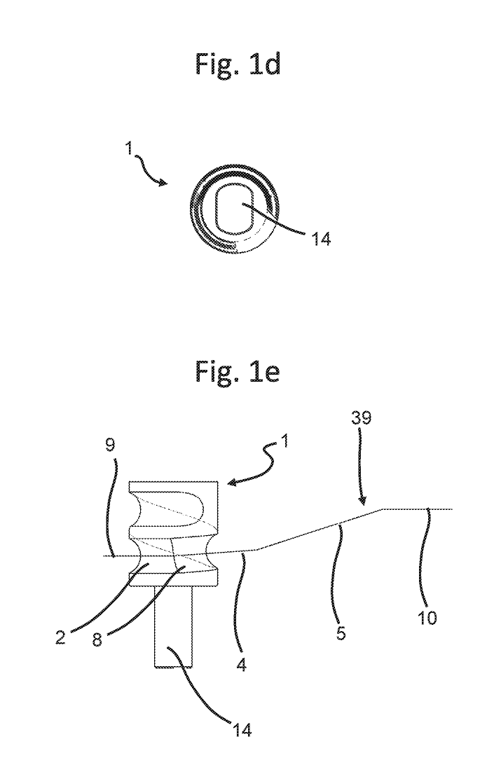

FIGS. 1a to 1e show a pull and/or push rod 1 which is adjustable along the longitudinal axis of a rod. This has a cam 2 for guiding a control member 3 which comprises an at least partially spiral-shaped coil section 8 having at least one or several slope portions 4, 5, 6, 7.

The cam 2 further comprises at least one idle stroke section 9, 10 which adjoins the coil section 8, substantially radially extending to the rod longitudinal axis and preferably arcuate in shape. In the embodiment, exactly two of the idle stroke sections 9, 10 are provided, of which a first idle stroke section 9 is disposed at a first end of the coil section 8, and of which a second idle stroke section 10 is arranged at the second end of the coil section 8, which lies opposite the first end. Preferably, the idle stroke sections 9, 10 of the pull and/or push rod 1 extend radially by up to 90 degrees, relative to the rod longitudinal axis. In other words, the idle stroke section 9, 10 thus extends such that it substantially always lies on a normal, relative to the rod longitudinal axis.

FIGS. 1a to 1e further show that the cam 2 is formed on an outer circumference 12 of the pull and/or push rod 1. Further, the pull and/or push rod 1 has an extension 14 having a non-circular cross-section (FIG. 1d). This extension 14 extends axially and has a rectangular cross-section with rounded corners. Due to the non-circular shape of the extension 14, a rotary motion can be transmitted to the pull and/or push rod 1.

FIG. 1e shows the spiral characteristic 39 of the pull and/or push rod 1. It provides a first slope portion 4 with a low pitch and a second slope portion 5 with a higher pitch, relative to the low pitch. The first slope portion 4 of the coil section 8 is inclined between 2 degrees and 6 degrees relative to the normal to the rod longitudinal axis, preferably it is arranged inclined by exactly 4 degrees relative to the normal of the rod longitudinal axis. The second slope portion 5 of the coil section 8 is inclined between 14 degrees and 22 degrees relative to the normal of the rod longitudinal axis, preferably it is arranged inclined by exactly 18 degrees to the normal of the rod longitudinal axis.

The first slope portion 4 having a low pitch thus leads to a low axial stroke of the pull and/or push rod 1, wherein a high force can be achieved (release stroke). The second slope portion 5 with a high gradient causes an axial stroke of the pull and/or push rod 1 in a shorter time, but with a lower force (fast stroke).

The spiral characteristic 39 also shows that a first idle stroke section 9 connects to the first slope portion 4 of the coil section 8. Furthermore, it is shown that a second idle stroke section 10 connects to the second slope portion 5 of the coil section 8. If a control member 3 is located within the respective idle stroke sections 9, 10, the axial movement of the pull and/or push rod 1 is blocked and the pull and/or push rod 1 is axially fixed in its position.

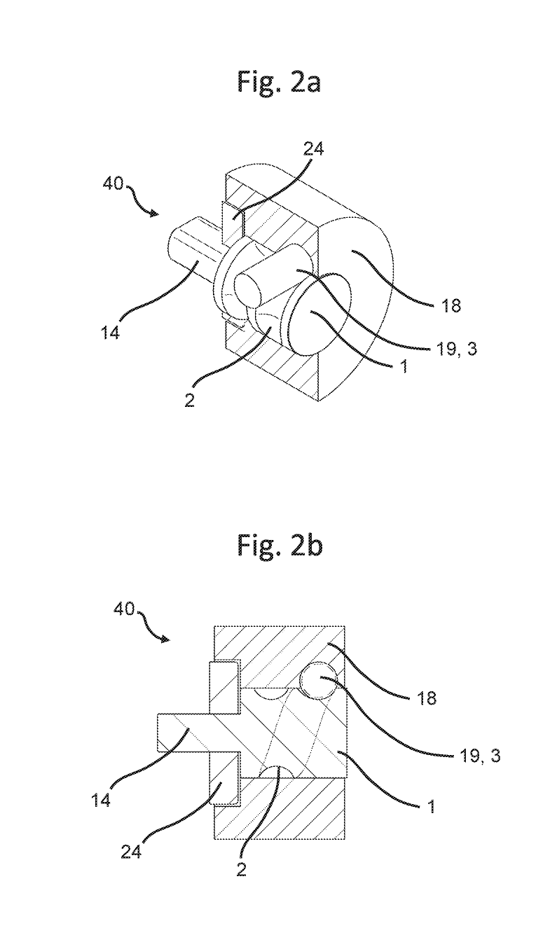

FIGS. 2a and 2b show an axial positioning system 40 with a pull and/or push rod 1 according to FIGS. 1a to 1e. Here, a control member 3 formed as a control pin 19 engages in the cam 2 of the pull and/or push rod 1. The cross section of the pull and/or push rod 1 is in this case formed rotationally symmetrical. The control pin 19 is axially fixed in the housing 18. Furthermore, a driving flange 24 is shown which can be rotationally driven by an electric motor 17 and which is non-rotatably connected to the extension 14 of the pull and/or push rod 1. This driving flange 24 thereby allows an axial relative movement of the pull and/or push rod 1. This means that the connection between the driving flange 24 and the pull and/or push rod 1 is designed non-rotatable but axially displaceable. If the pull and/or push rod 1 is rotated by the driving flange 24, the control pin 19 glides along the cam 2, whereby the pull and/or push rod 1 is moved axially forward, i.e. out of the housing 18, or axially rearward, i.e. into the housing 18.

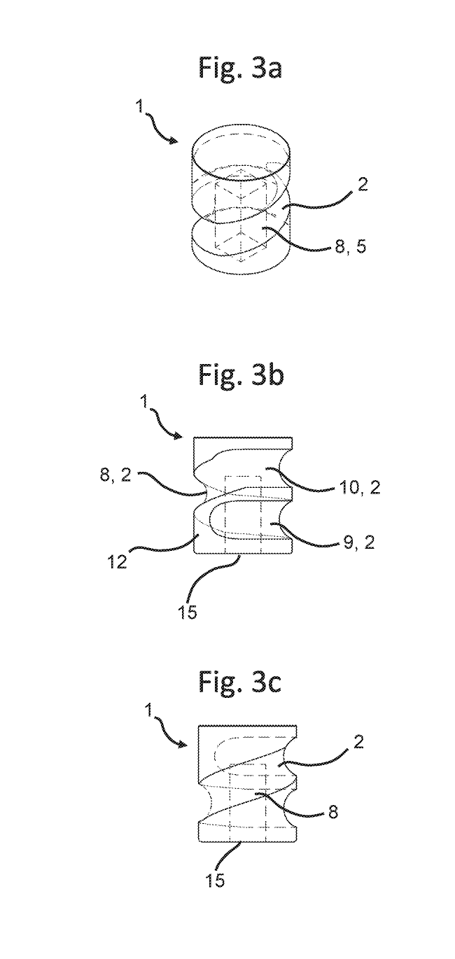

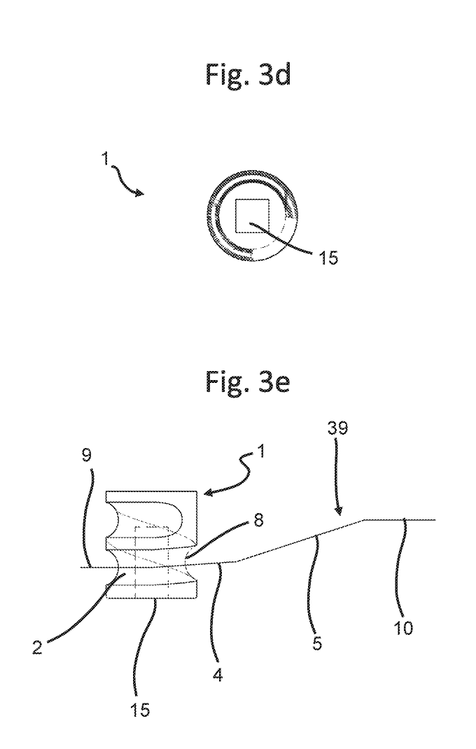

FIGS. 3a to 3e show a second pull and/or push rod 1 which in its basic structure corresponds to that of FIGS. 1a to 1e. In contrast to the pull and/or push rod 1 according to FIGS. 1a to 1e, however, it does not include an extension 14 having a non-circular cross-section, but instead has an inner receptacle 15 having a non-circular cross-section. Thus, the overall length of the pull and/or push rod 1 of this embodiment is designed very short, in particular compared to those of the embodiment shown in FIGS. 1a to 1e. The outer contour, in particular the cam 2, is consistent in both the coil section 8 as well as the idle stroke section 9, 10 to that of FIGS. 1a to 1e. Similarly, the pull and/or push rod 1 has the same spiral characteristic 39 as that of FIGS. 1a to 1e.

FIGS. 3a to 3c show that the pull and/or push rod 1 has a closed configuration at the end facing away from the inner receptacle 15. This has the advantage that no contamination can occur in those drive connections which cause a rotational and/or axial movement of the pull and/or push rod 1. FIG. 3d also shows that the cross section of the inner receptacle 15 is formed as a polygon, shown here as a square.

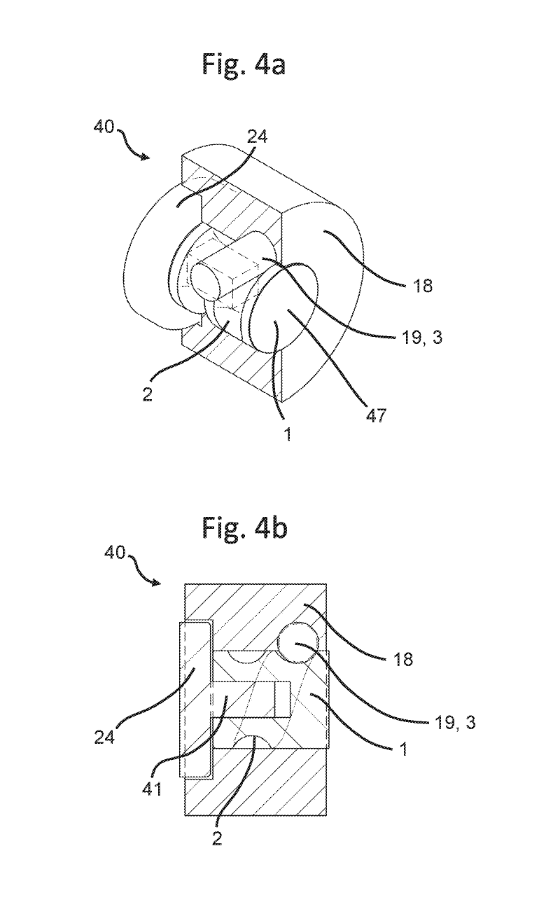

FIGS. 4a and 4b show an axial positioning system 40 having a pull and/or push rod 1, comprising a cam 2, and in which a control member 3 (guide member) formed as a control pin 19 (guide pin) engages. The control pin 19 is axially fixed in a housing 18.

This control pin 19 can also be mounted rotatably around its longitudinal axis pin in the housing 18, whereby the adjustment of the pull and/or push rod 1 takes place in a friction-reducing manner. Further, a driving flange 24 rotationally drivable by an electric motor 17 is provided which has an actuating extension 41 which in its cross-section corresponds to the cross-section of the inner receptacle 15 of the pull and/or push rod 1. The advantage of this embodiment of an axial positioning system 40 is the short overall length, especially as compared to those of the axial positioning system 40 shown in FIGS. 2a and 2b. The actuating extension 41 of the driving flange 24 is designed in such a way that it forms a non-rotatable but axially displaceable connection with the pull and/or push rod 1. If the pull and/or push rod 1 is rotated by the driving flange 24 or by the actuating extension 41, then the control pin 19 slides along the cam 2, whereby the pull and/or push rod 1 is displaced axially forward, i.e. out of the housing 18, or backward, i.e. into the housing 18.

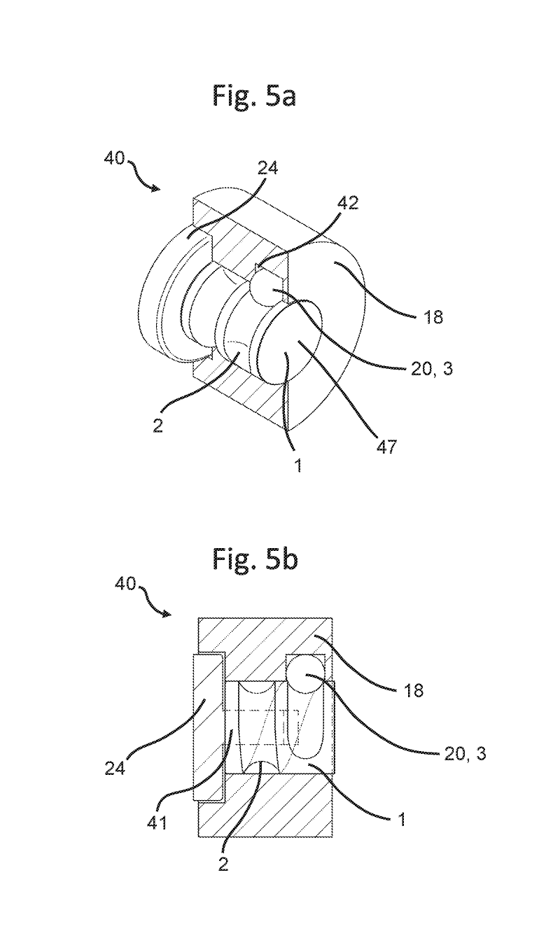

FIGS. 5a and 5b show a system corresponding to the one in FIGS. 4a and 4b, whereas here, instead of a control pin 19, a control member 3 formed as a control ball 20 (guide ball) is positioned in the cam 2 of the pull and/or push rod 1. This control ball 20 is axially fixed in a receiving pocket 42 in the housing 18 and can slide along the cam 2. Likewise, it is possible that the control ball 20 rotates in the receiving pocket 42 about its own axis, so that the friction of the entire system is reduced.

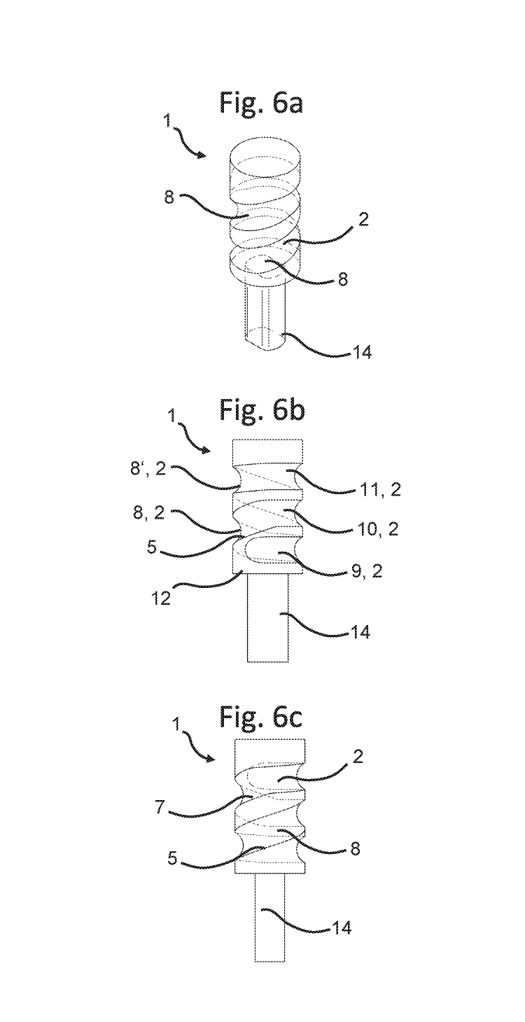

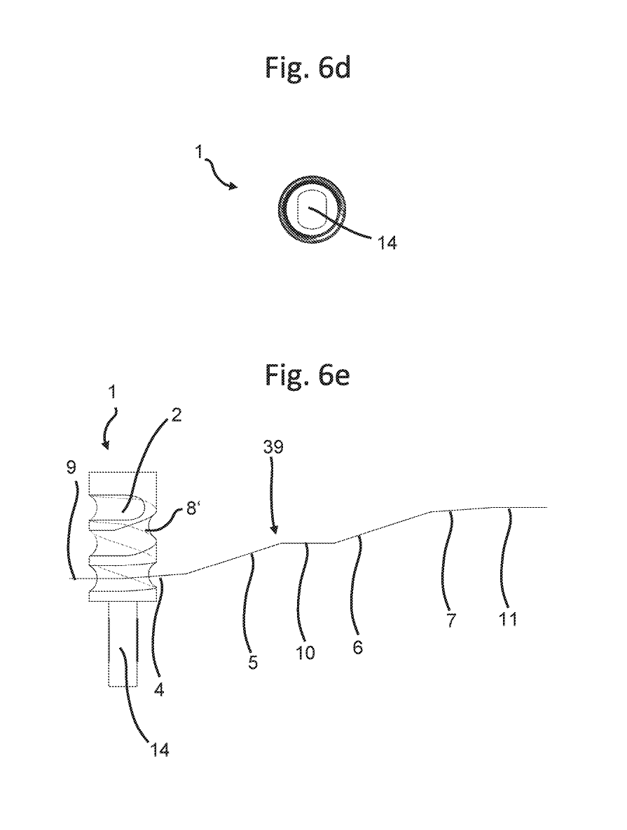

FIGS. 6a to 6e show a third pull and/or push rod 1, which in its basic structure corresponds to the structure of the pull and/or push rod 1 according to FIGS. 1a to 1e. Here, however, the spiral characteristic 39 has been changed such that several, in this case exactly two, coil sections 8 are provided, which are separated from each other by an idle stroke section 10. The cam 2 formed at the outer periphery 12 of the pull and/or push rod 1 accordingly has a first idle stroke section 9, followed by a first slope portion 4. A second slope portion 5 formed as a fast stroke adjoins the first slope portion 4 formed as a release stroke. A second idle stroke section 10 connects to the coil section 8 formed from the first slope portion 4 and the second slope portion 5. A third slope portion 6 of a further coil section 8, also formed as a fast stroke, in turn connects to this second idle stroke section 10. A fourth slope portion 7 formed as a release stroke (also power stroke) is disposed downstream of the third slope portion 6. A third idle stroke section 11 connects at the fourth slope portion 7.

The pull and/or push rod 1 (or tension and/or pressure bolt) shown in FIGS. 6a to 6e is also formed with an extension 14 having a non-circular cross-section, which serves for the transmission of rotary movements. Like the pull and/or push rod 1 according to FIGS. 1 to 5, the pull and/or push rod 1 of FIGS. 6a to 6e is also formed such that it is axially adjusted, provided that a control member 3 engages in the cam 2 and provided that a relative rotation takes place with respect to the control member. When rotated counterclockwise, the rod moves axially in the direction of the extension 14. It moves axially opposite the direction of the extension 14 when rotated in the clockwise direction. Of course, it is also possible to reverse the sense of rotation of the cam 2 so that if the pull and/or push rod 1 is rotated counterclockwise, an axial displacement is carried out against the direction of the extension 14.

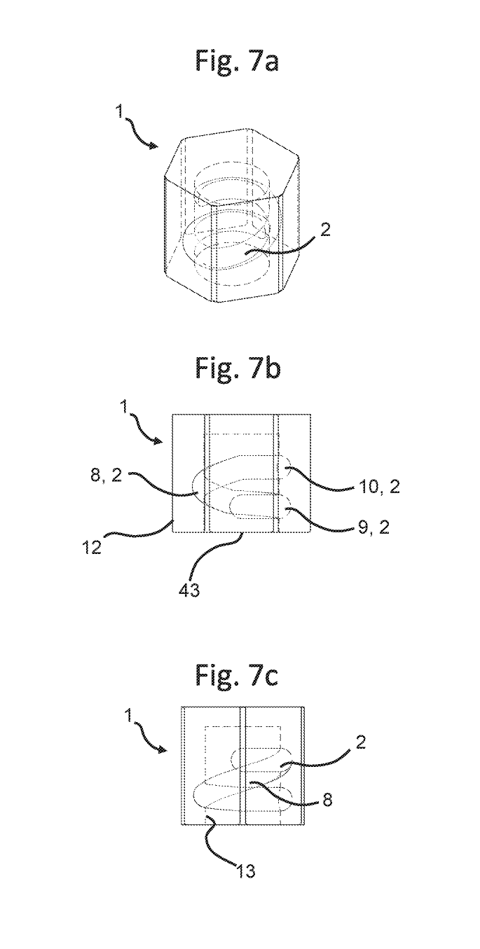

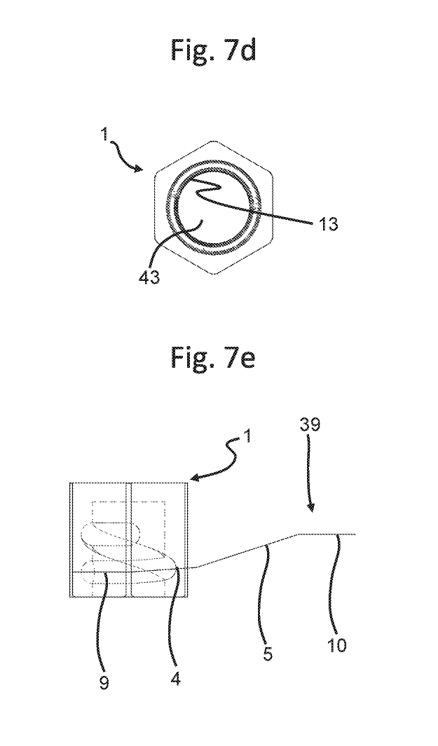

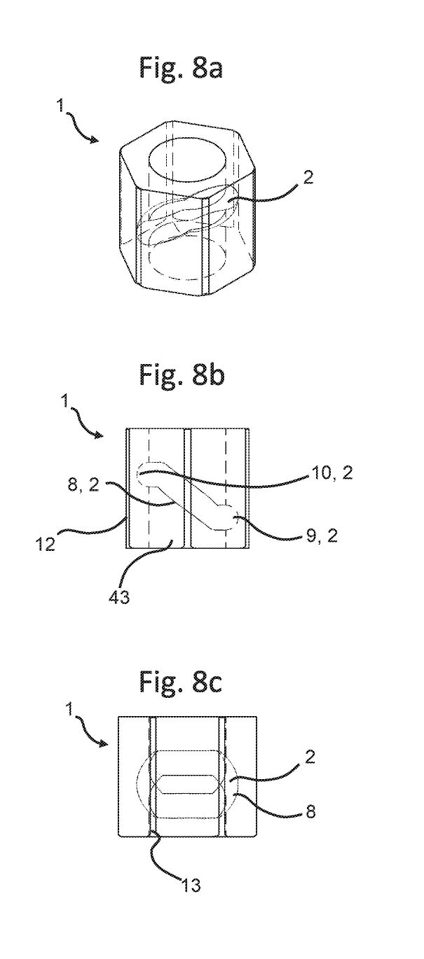

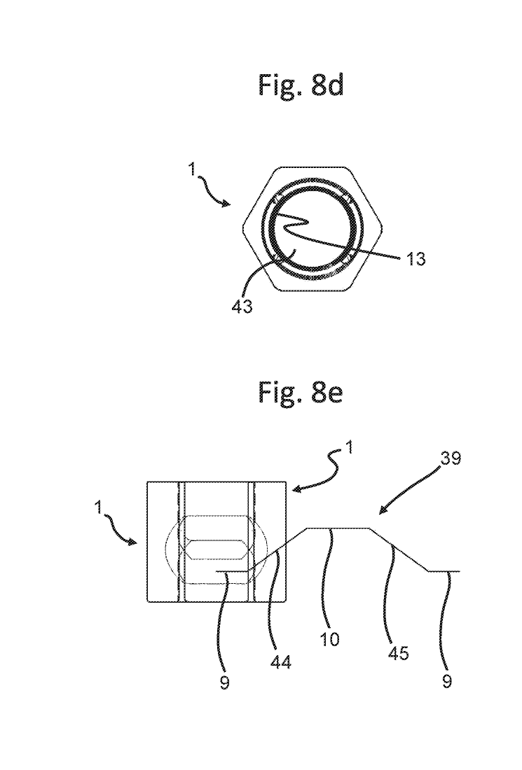

FIGS. 7a to 7e and FIGS. 8a to 8e show further embodiments of a pull and/or push rod 1 which are adjustable along a rod longitudinal axis and which have a cam 2 for guiding a control member 3. The pull and/or push rod 1 shown here has an inner recess 43. It is further partially formed as a hollow rod, wherein at the inner periphery of the hollow rod 13, i.e. in the wall of the inner recess 43, the cam 2 is formed. The cam 2 shown here has a coil section 8 having one or more slope portions 4, 5, according to the embodiment of FIGS. 7 and 8, further comprising a first idle stroke section 9 adjoining the coil section 8 and a second idle stroke section 10 adjoining the coil section 8. Further, the outer contour of the pull and/or push rod 1 is non-circular in shape so that it can be non-rotatably fixed but axially displaceable in a housing 18. The inner recess 43, however, is cylindrical in shape so that it can engage with an actuating element 31 having a round cross-section.

The spiral characteristic 39 illustrated in FIG. 7e shows that the coil section 8 comprises a first slope portion 4 with low pitch (power stroke or release stroke) and a second slope portion 5 with high pitch (fast stroke).

FIGS. 8a to 8e show a pull and/or push rod 1 of which the cam 2 is formed in the shape of a closed spiral groove. The spiral characteristic 39 in FIG. 8e shows that the cam 2 includes a first idle stroke section 9, to which a first coil section 44 connects. The first coil section 44 is followed by a second idle stroke section 10. A second coil section 45 adjoins at this second idle stroke section 10, which again merges into the first idle stroke section 9 due to the spiral groove 5 (cam) that is formed circumferentially to the inner recess 43. Further, the inner recess 43 is continuously designed so that the pull and/or push rod 1 is formed as a pressure sleeve.

The spiral characteristic 39 of the pull and/or push rod 1 according to FIGS. 8a to 8e means that the pull and/or push rod 1 constantly switches between the release position and the clamping position when a control member 3 rotationally driven in only one direction slides in the spiral groove. This has the advantage that to switch the pull and/or push rod 1 between the release position and the clamping position, the reversal of rotational direction of a motor is not required. In this way, switching times of the system are shortened and programming effort is reduced.

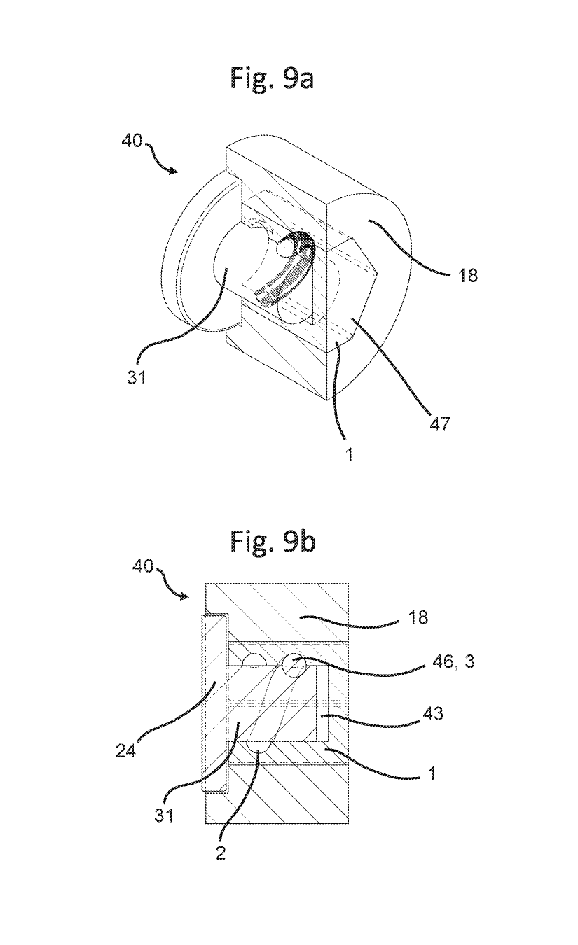

FIGS. 9a and 9b show an axial positioning system 40 which comprises a pull and/or push rod 1 as shown in FIGS. 7a to 7e. The housing 18 has an inner contour which is adapted to the outer contour of the pull and/or push rod 1, whereby the pull and/or push rod 1 is non-rotatably guided inside the housing 18. In order to facilitate the axial sliding of the pull and/or push rod 1, either its outer contour and/or the inner contour of the housing 18 can be provided with a friction-reducing coating. In order to maintain functionality, however, alternatively play can be left between the housing 18 and the pull and/or push rod 1 in such a way that in principle, a rotational movement of the pull and/or push rod 1 is prevented, but enough space remains to permit an axial movement of the pull and/or push rod 1 within the housing 18. The driving flange 24 of the system comprises an actuating element 31 which engages in the rotationally symmetrical, in particular cylindrical, inner recess 43 of the pull and/or push rod 1. At the actuating element 31, the control member 3 is arranged in the form of a calotte 46 or in the form of a control ball 20. The control member 3 is preferably fixedly connected to the actuating element 31. If the driving flange 24 is now rotationally driven, the actuating element 31 is rotated with the control member 3 within the inner recess 43 of the pull and/or push rod 1. In this case, the control member 3 slips along the spiral groove, forcing the hollow pull and/or push rod 1 in an axial movement, which results from its rotationally fixed mounting within the housing 18. Also in this embodiment, the hollow rod is cup-shaped, i.e. formed closed on one side, so that a pressure or traction surface 47 is available on the side facing away from the driving flange 24.

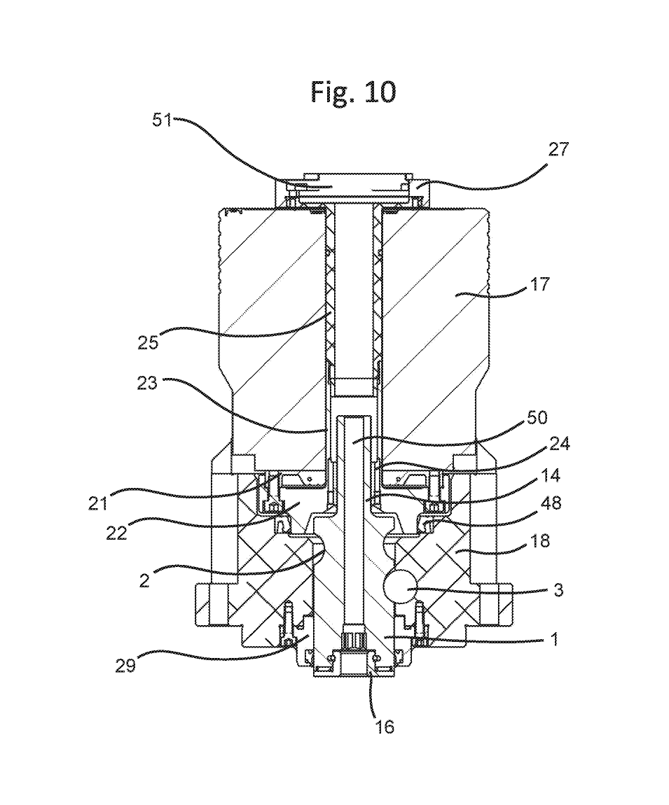

FIGS. 10 to 12 show an example of an electric release unit which is actuated by means of an electric motor 17. The electric motor 17 preferably has a rotationally driven drive spindle. The electric release unit also provides a pull and/or push rod 1 which is movable along a rod longitudinal axis within a housing 18 and which has a cam 2 for guiding a control member 3 with an at least partially spiral, coil section 8 having one or more slope portions 4, 5.

In the present embodiment, the control member 3 is axially fixed in the housing 18. If the pull and/or push rod 1 is spindled, it is axially displaced within the housing 18. In order to decouple the spindle movement, a rotatable cap 16 or a thrust bearing is disposed on the side facing away from the electric motor 17. The pull and/or push rod 1 is preferably formed in accordance with the embodiment of FIGS. 1a to 1e and comprises a first idle stroke section 9, which essentially extends radially to the rod longitudinal axis and which adjoins the coil section 8. Further, a second idle stroke section 10 also substantially formed radially to the rod longitudinal axis, is connected to the coil portion 8.

On the side of the pull and/or push rod 1 facing away from the rotatable cap 16, an extending projection 14 having a non-circular cross-section is provided, via which the rotational movement of the electric motor 17 is transferable to the pull and/or push rod 1.

In the present embodiment, the control member 3 which engages in the cam 2, is formed as a control pin 19, which is axially fixed in the housing 18 of the electric release unit. It is also possible, that the pin is mounted to rotate about its longitudinal pin axis, whereby the cam 2 is also prevented from blocking or tilting the control pin 19.

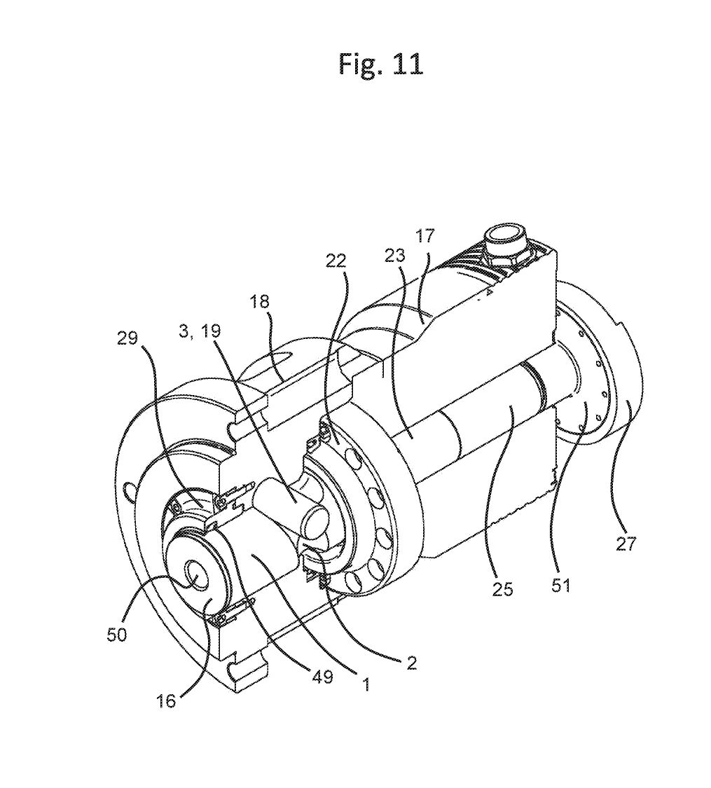

FIG. 11 shows the electrical release unit in the clamping position, wherein the control pin 19 is positioned in the second idle stroke section 10 (upper end position). When the control pin 19 is in an idle stroke section 10, the pull and/or push rod 1 is axially locked in the housing 18.

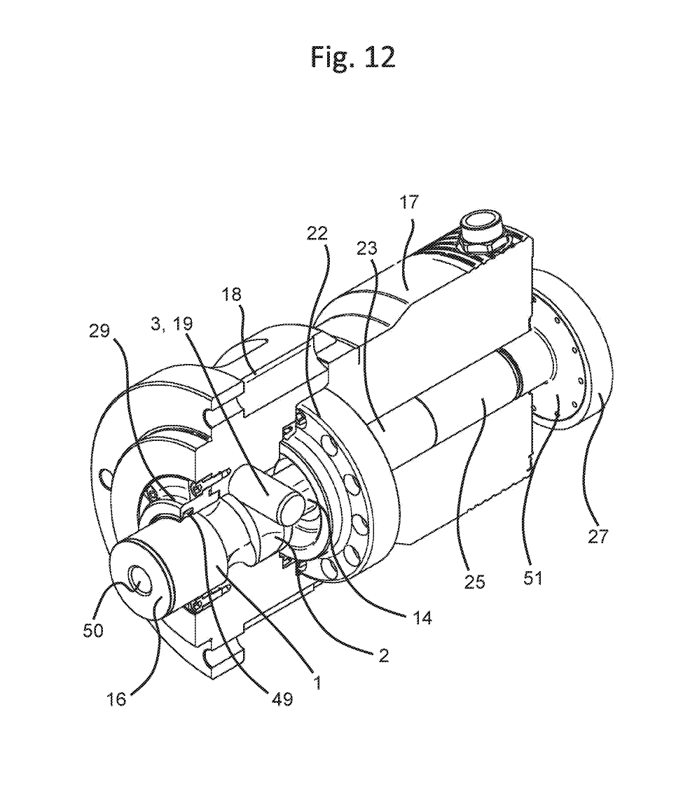

In order to move the pull and/or push rod 1 to the release position shown in FIG. 12, the electric motor 17 is driven, which in turn transfers its rotary motion to the extension 14 of the pull and/or push rod 1. The rotation of the pull and/or push rod 1 causes the control pin 19 to slide along the idle stroke sections 10—initially without a stroke movement of the rod. Thus, the electric motor 17 can build up its full torque or its full speed—stroke-free—before the control pin 19 reaches the coil section 8. Only the sliding of the control pin 19 in the coil section 8 effects a stroke movement of the pull and/or push rod 1 relative to the housing 18.

In the present embodiment, the control pin 19 first reaches the second slope portion 5 of the coil portion 8 with a large pitch with respect to the normal to the rod longitudinal axis, which provides a fast stroke. If the pull and/or push rod 1 is rotated further, the control pin 19 reaches the first slope portion 4 of the coil section 8 with a slight pitch with respect to the normal to the rod longitudinal axis, which provides a power stroke.

In other words, using a high pitch at a slope portion 4, 5, 6, 7 means the occurrence of a large axial stroke with a small force, whereby a slight pitch of a slope portion 4, 5, 6, 7 results in a low axial stroke with a high force.

Once the control pin 19 has passed through the first slope portion 4 (power stroke), the guide pin 19 reaches the first idle stroke section 9 of the cam 2, causing the pull and/or push rod 1 to be locked in the release position, no longer allowing axial travel (rear end position of the rod).

In order to move the electrical release unit from the release position back into the clamping position, the pull and/or push rod 1 needs to be rotated in the opposite direction, whereby the guide pin 19 passes through the cam 2 in the opposite direction until it has again reached the second idle stroke section 10 (front end position of the rod).

So that a high torque can be transmitted to the extension 14 or the pull and/or push rod 1, it has proven useful when an eccentric gear, preferably a harmonic drive, is arranged between the output or the drive spindle of the electric motor 17 and the pull and/or push rod 1. Preferably, the eccentric gear thereby provides a relatively large reduction, for example, 1 to 50 in the present example.

The electric motor 17 or the drive spindle of the exemplary embodiment includes a mounting flange 21 which is at least indirectly non-rotatably coupled with the pull and/or push rod 1. In the present case, the drive spindle is thus connected via the harmonic drive to the mounting flange 21, which is in turn connected with the driving flange 22, which has an axially extending drive collar 23. Inside the housing 18, a sealing ring 48 or sliding ring is disposed, which is arranged coaxially to the output of the electric motor 17 and serves to seal the interior or alternatively, serves as a slide bearing of the driving flange 22. A driving flange 24 with a non-circular cross-section is connected to the drive collar 23, which is coupled non-rotatably but axially displaceable to the extension 14 of the pull and/or push rod 1. In this context, the driving flange 22, the drive collar 23 and the driving flange 24 can be designed separately, but also at least in some cases, integrally. The mounting flange 21 generally constitutes a part of the electric motor 17.

In order for the adjustment of the pull and/or push rod 1 to require the least possible force within the housing 18, the housing 18 includes a slide bush 29 which encloses the pull and/or push rod 1. In the present case, the slide bush 29 is screwed to the end face of the housing 18. Within this slide bush 29, additionally a stripping mechanical seal 49 is included in a sliding ring receptacle, which, for example, is formed from a self-lubricating plastic. The mechanical seal 49 seals inwards and prevents the penetration of dirt from outside (stripping). For weight reduction or for conducting media (fluids), the pull and/or push rod 1 has a channel 50 which is configured in the longitudinal direction.

The electric release device shown is further advantageously developed in that the drive collar 23 is non-rotatably coupled to a sensor sleeve 25, which has a sensor target 27 with a peripheral slope 26. The sensor sleeve 25 is configured in multiple parts with a target holder 51, with which the sensor target 27 is releasably or fixedly connected.

The sensor target 27 as such is part of a sensor system 52 for measuring the axial position of an element, e.g. of a pull and/or push rod 1 of the present invention. Below, the sensor system 52 separately disclosed herein is explained in more detail with reference to FIGS. 27 to 29. The sensor system may also be used in separating devices, gripping devices or parallel grippers, or in systems where accurate detection and resolution of a rotation is of an advantage.

The sensor target 27 has a peripheral slope 26, i.e. the sensor target 27 is formed with a rising or falling radius, depending on the rotational position and rotational direction. Preferably, the radius r (A) on the outer periphery of the sensor target 27, which is dependent of the rotation angle A, can be expressed by the following formula: radius r(A)=r0+(Y×A/360 degrees), wherein A is the angle of rotation, r0 the basic radius and Y is the maximum surcharge to the radius r0. Thus, depending on the rotational position of the sensor target 27, another radial distance 66 from a stationary distance sensor 53 (displacement sensor), preferably arranged on the housing 18, is present. Likewise, the distance between the outer side to the center 54 of the target is dependent on the angle of rotation A.

At its front end 55, i.e. its side facing away from the electric motor 17, the sensor target 27 has an elevation 56 which at least partially extends circumferentially. This elevation 56 is higher than a base 57, preferably by an amount between 2 and 4 mm, preferably by exactly 3 mm. At the front side, a distance sensor 58, in particular an inductive proximity switch, is disposed which detects the distance 67 to the front end 55 of the sensor target 27. The distance 67 is less if the sensor target 27 is in a rotary position, in which the elevation 56 sits opposite the distance sensor 58. Conversely, the distance 67 is greater if the base 57 sits opposite the distance sensor 58.

This has the advantage that it now can be determined whether the rotational movement corresponds to an idle stroke or to an actual axial adjustment (stroke movement). Here, the arc portion 59 communicates to the elevation 56 by how many degrees the respective idle stroke section 9, 10, 11 of the cam 2 radially extends relative to the rod longitudinal axis. The opening angle B of a line extending from the center point 54 of the sensor target 27 to the first stage 60 of the elevation 56, and a line extending from the center point 54 of the sensor target 27 to the second stage 61 of the elevation 56 are thereby identical to the opening angle under which the idle stroke section or sections 9, 10, 11 extend. Thus, when the idle stroke section 9, 10, 11 extends by 90 degrees, the opening angle between the first stage 60 and the second stage 61 relative to the center 54 of the target 27 is also 90 degrees. Therefore, the elevation 56 in the end face can detect whether an axial stroke is performed.

The amount by which the axial stroke takes place, is, however, detected by the radial distance between the sensor target 27 and the radially disposed distance sensor 53. The more the sensor target 27 is rotated, the smaller the distance 66 between the displacement sensor and the sensor target 27, due to the circumferentially arranged peripheral slope 26. In the embodiment shown, the measurement of the axial stroke is recorded over 270 degrees. Only when a 270-degree rotation is reached does the end-face distance 67 of the sensor target 27 again decrease towards the front-side distance sensor 58, thereby detecting that a control member 3 has again reached an idle stroke section 9, 10, 11. Combining distance measurements by the radial distance sensor 53 and the axial inductive proximity switch 58, the respective end positions (upper or lower end position) can be clearly detected.

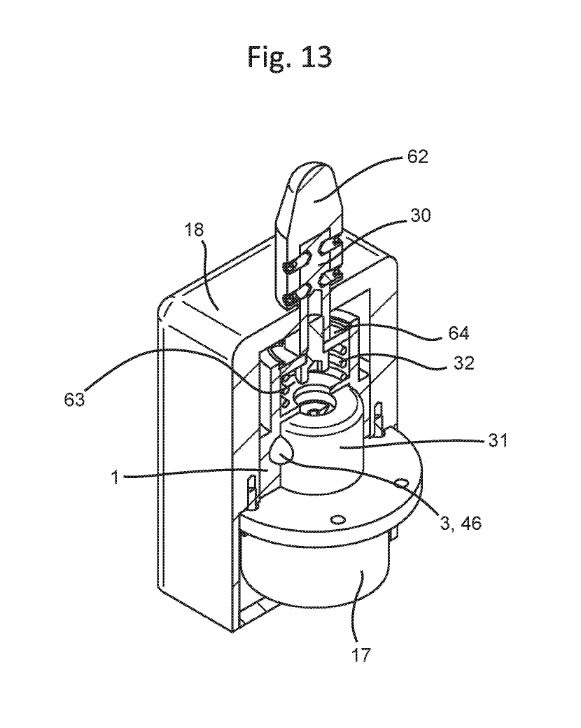

FIGS. 13 to 16 show an electrical separation device with a pull and/or push rod 1, non-rotatably but axially displaceably guided in a housing 18 and connected to a separating finger 30. This pull and/or push rod 1 is adjustable along a rod longitudinal axis and has a cam 2 for guiding a control member 3, having a coil section 8 which is at least partially spiral-shaped and includes one or more slope portions 4, 5.

In the illustrated embodiment, an idle stroke section 9, 10 essentially radially extending to the rod longitudinal axis adjoins the coil section 8 of the cam 2. In the present case, two idle stroke sections 9, 10 are provided, wherein the cam 2 is formed as a spiral groove. The pull and/or push rod 1 is additionally at least partially formed as a hollow rod, wherein the cam 2 is formed in an inner periphery 13 of the hollow rod.

The pull and/or push rod 1 of the electrical separation device essentially corresponds to the tension and/or compression bar 1 of FIGS. 8a to 8e. A rotationally symmetrical actuating element 31 which is fixedly connected to the drive spindle of an electric motor 17, engages in the cylindrically shaped interior recess 43. A control member 3 in the form of a calotte 46 is arranged at this actuating element 31, which engages in the cam 2 for axial adjustment of the pull and/or push rod 1 between a separating position and an open position.

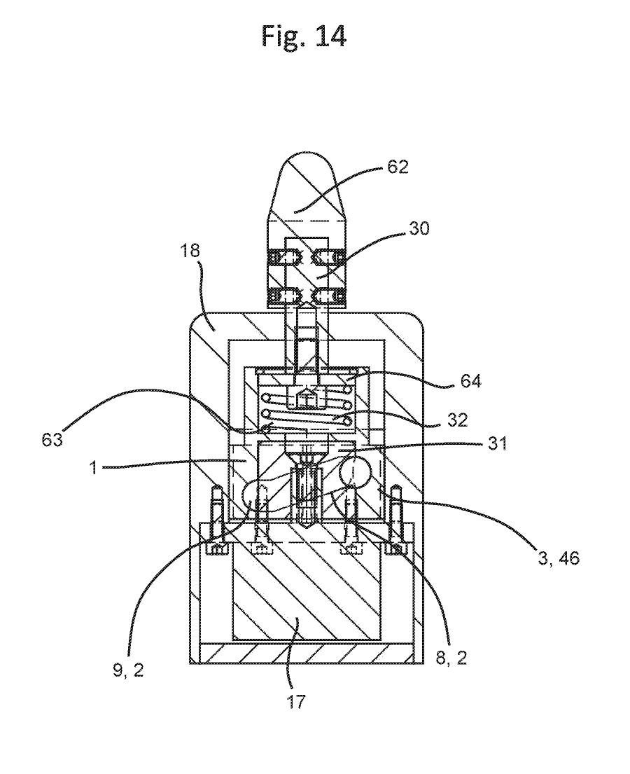

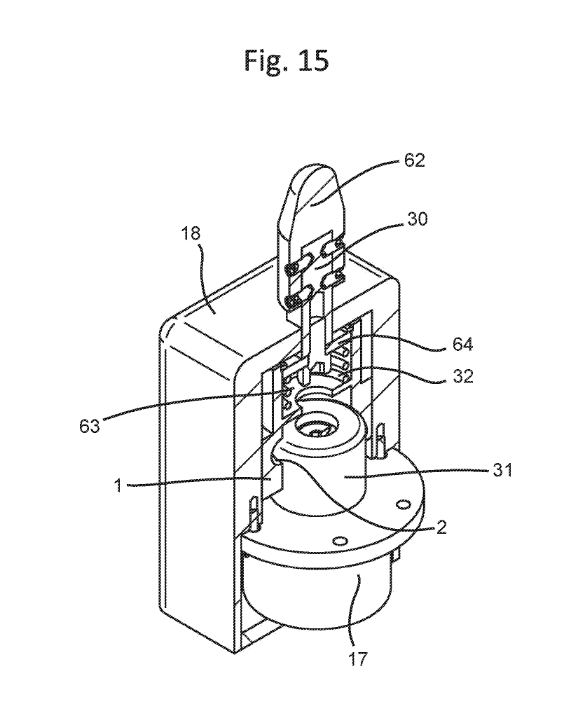

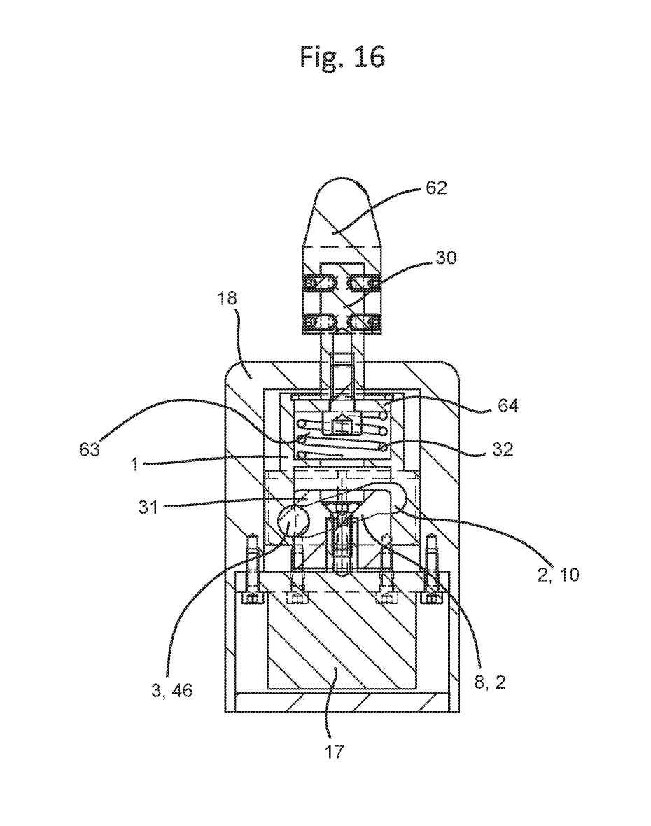

FIGS. 13 and 14 show the electrical separation device in the open position; FIGS. 15 and 16 show it in the separating position. The pull and/or push rod 1 is connected to a separating finger 30 and simultaneously non-rotatably but axially displaceably guided in the housing 18. In the present case, its outer periphery 12 is formed non-circular as a polygon, in particular as a hexagon. The inner contour of the housing 18 is formed such that the pull and/or push rod 1 is guided non-rotatably but axially displaceable in the housing 18.

Additionally, a protective cap 62, preferably formed from plastic, is attached to the separating finger 30. To damp forces axially acting on the separating finger 30, a spring package is arranged in the tension and/compression rod 1. In the present case, a cup-shaped recess 63 is formed on the side of the pull and/or push rod 1 facing away from the electric motor 17, in which a spring 32, in this example a spiral spring (compression spring), is inserted. This compression spring is supported by a collar 64 of the separating finger 30, which in this case is removably attached on the separating finger 30 by a screw. This collar 64 is in turn secured to the spring cup of the pull and/or push rod 1 by means of a snap ring. If forces that are too large act on the separating finger 30 in the direction of the electric motor 17 when in the clamping position, the spring 32 is compressed and the collar 64 moves back into the pull and/or push rod 1, i.e. towards the electric motor 17.

If the electric motor 17 is driven, the control member 31 is rotated, whereby the control member 3 slides in the cam 2 to the position (separation position) shown in FIGS. 15 and 16. In this position, the control member 3 formed as a ball is in an idle stroke section 9, so that the pull and/or push rod 1 is axially locked. Axial movement of the separating finger 30 is now only possible against the spring force of the spring 32. Since the cam 2 is formed as a spiral groove, the electric motor 17 can be driven in the same direction, i.e. without needing to change the rotating direction, whereby the pull and/or push rod 1 is again returned to the position shown in FIGS. 13 and 14 (open position). An alternative embodiment of the separating device does without the use of a spring.

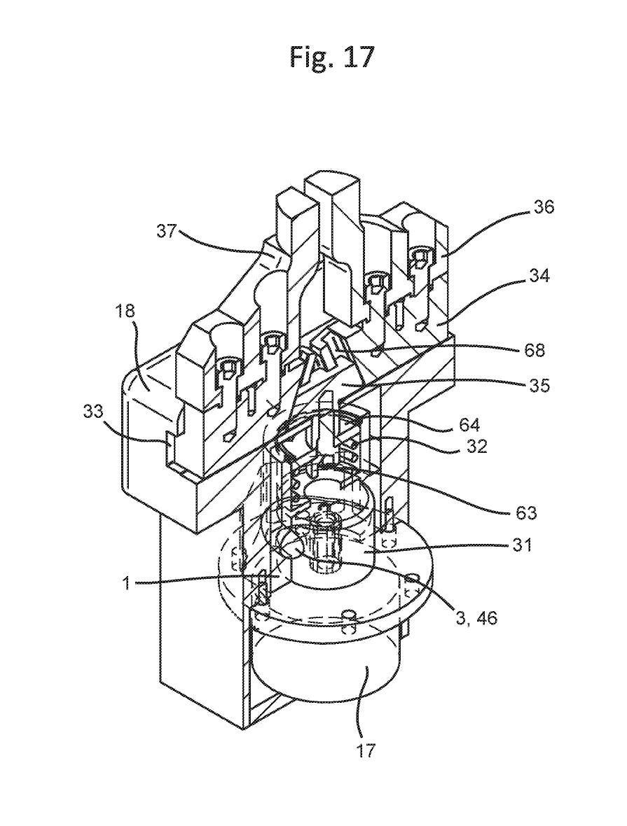

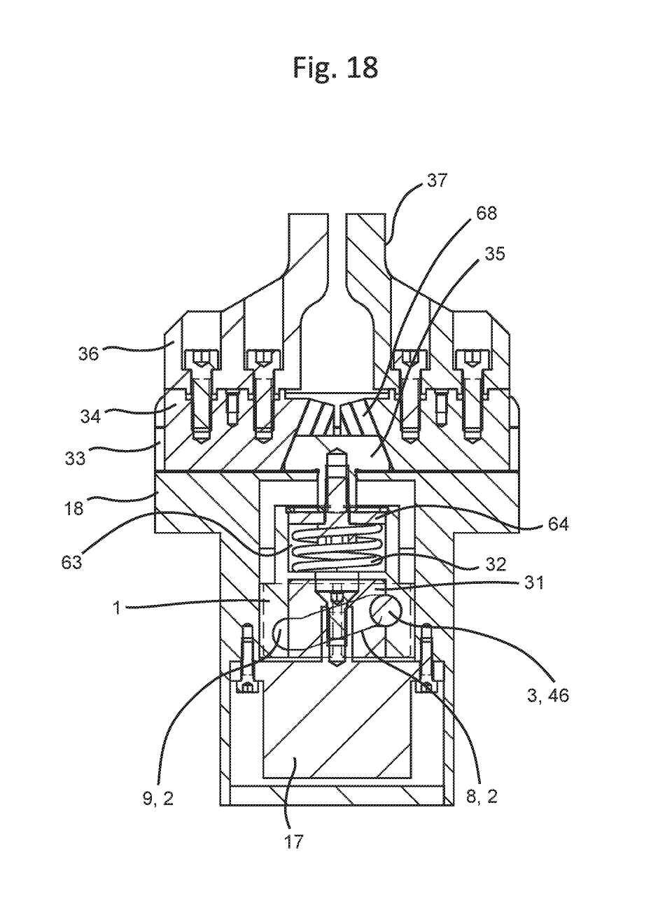

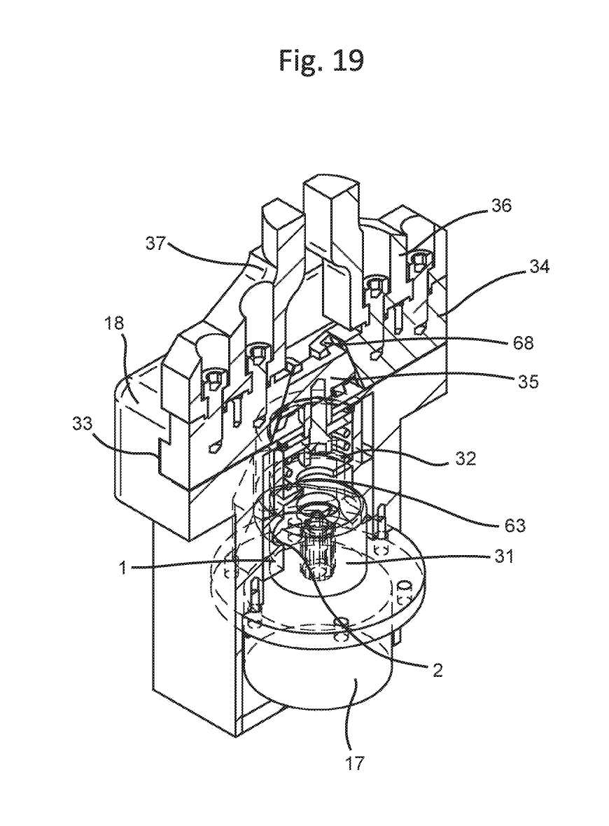

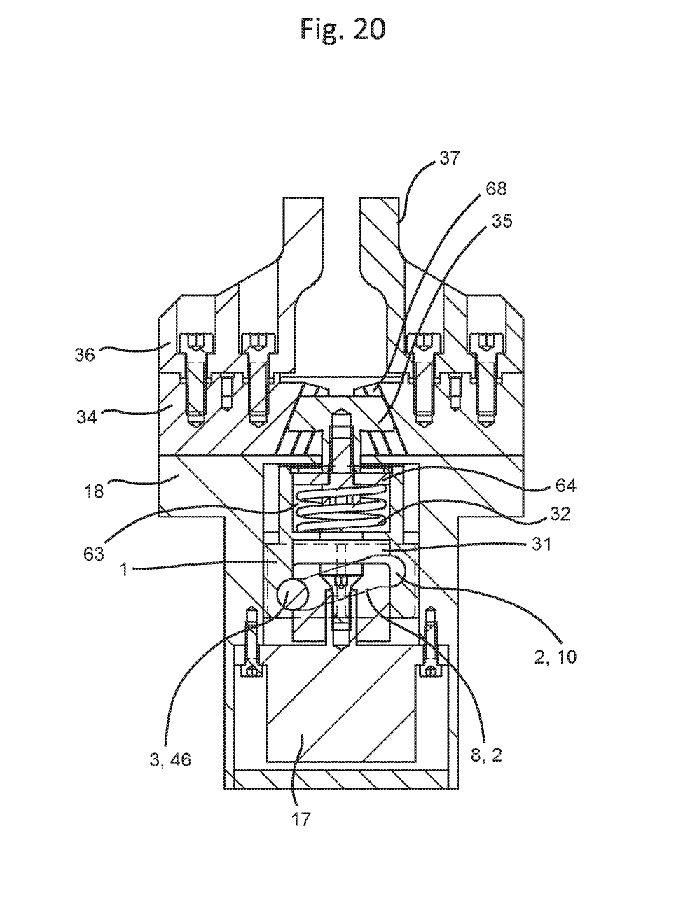

FIGS. 17 to 20 show a further embodiment of the inventive pull and/or push rod 1. These figures show an electric gripping device with gripper base jaws 34, which are radially adjustable to the gripper longitudinal axis and are guided in gripper grooves 33, and which interact with an axially adjustable wedge hook 35 over splines 68 which extend in a sloped manner to the gripper longitudinal axis. This wedge hook 35 is connected to a pull and/or push rod 1. This pull and/or push rod 1 is adjustable along a rod longitudinal axis and has a cam 2 for guiding a control member 3, which comprises an at least partially spiral coil section 8 having one or more slope portions 4, 5.

According to the present embodiment, the pull and/or push rod 1 is at least partially formed as a hollow rod, wherein the cam 2 is formed in an inner periphery 13 of the hollow rod. Alternatively, of course, the cam 2 can also be formed on an outer circumference 12. The pull and/or push rod 1 substantially corresponds to the pull and/or push rod 1 of FIGS. 8a to 8e. In the present case, an electric motor 17 is provided which is non-rotatably coupled with an actuating element 31, at which a control member 3 is arranged. The control member 3 engages in the cam 2 which is formed as a spiral groove for axial adjustment of the pull and/or push rod 1 between a closed position and an open position (and if needed, a clamping position which sits between the closed position and the open position). If the pull and/or push rod 1 is adjusted axially forward, i.e. in the direction of the gripper grooves 33, the wedge hook 35 or wedge cone forces the gripper base jaws 34 radially outwardly within the gripper grooves 33. In a gripper according to FIGS. 17 to 20, this corresponds to a motion in the clamping position or closed position. In this case, the control member 3 slides within the cam 2 along the coil section 8 towards a first idle stroke section 4 which adjoins the coil section and substantially extends radially to the rod longitudinal axis. Within this first idle stroke section 4, an axial movement of the pull and/or push rod 1 is prevented, therefore axially locking it. If the actuating element 31 is rotated further, the guide member 3 within the guide groove 2 slides back toward the second idle stroke section 5, whereby according to FIGS. 17 to 20, the gripper re-opens to the open position.

As soon as the control member 3 has again reached the first idle stroke section 4, the pull and/or push rod 1 is again axially fixed, i.e. locked, in the housing 18.

In this embodiment of an electric gripper device, a spring 32 is arranged in the pull and/or push rod 1 to damp forces which act radially on the gripper base jaws 34. The spring assembly, in turn, corresponds to the arrangement which was already described for the separating device. By altering the arrangement of the spring assembly, the gripper is adapted for external gripping.

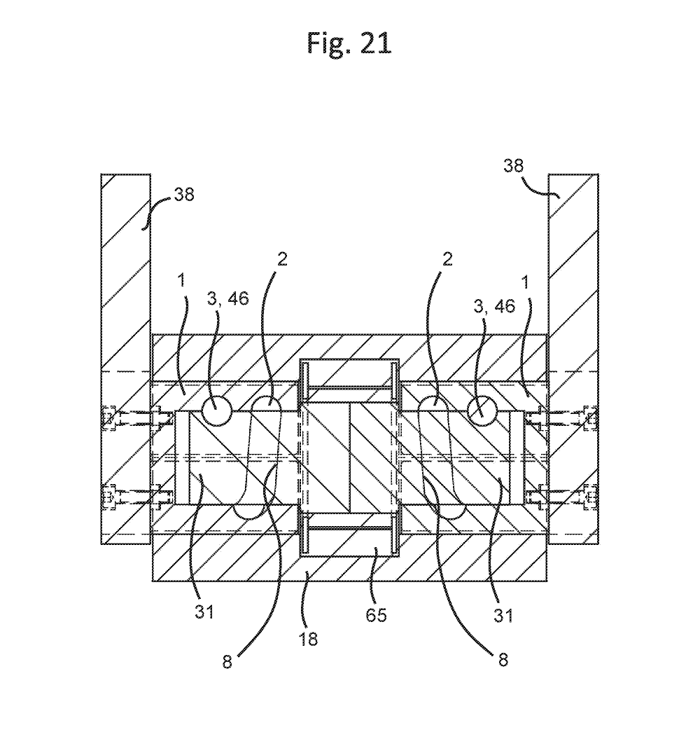

FIGS. 21 to 24 show a gripping device in the form of an electric parallel gripper. This parallel gripper comprises two gripper arms 38 with a number of pull and/or push rods 1 which correspond to the number of gripper arms 38. In the present embodiment, one gripper arm 38 each is releasably connected with each pull and/or push rod 1. The pull and/or push rods 1 are partially formed as a hollow rod, wherein at the inner periphery 13 of the hollow rod, a cam 2 for guiding a control member 3 is formed which has an at least partially spiral coil section 8 having one or more slope portions 4, 5.

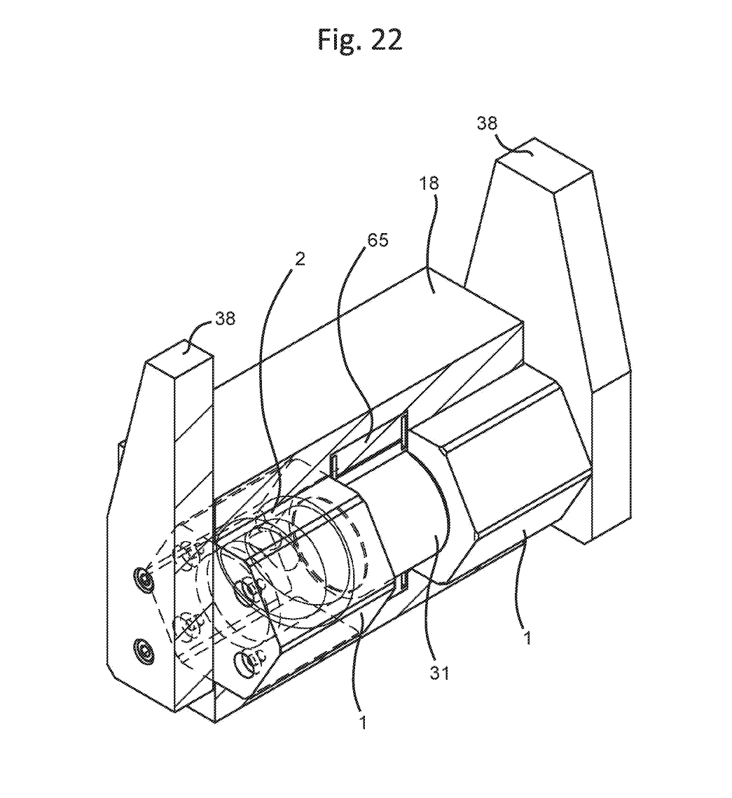

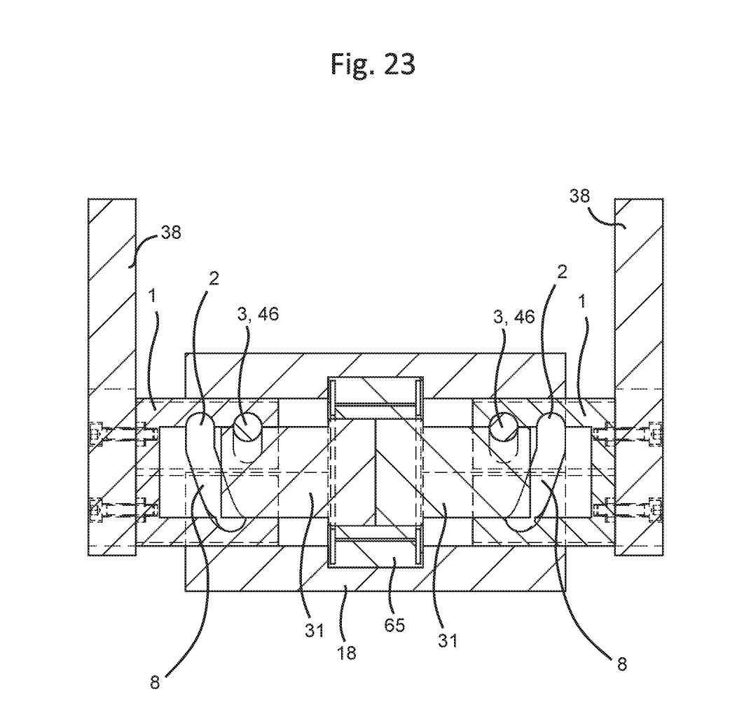

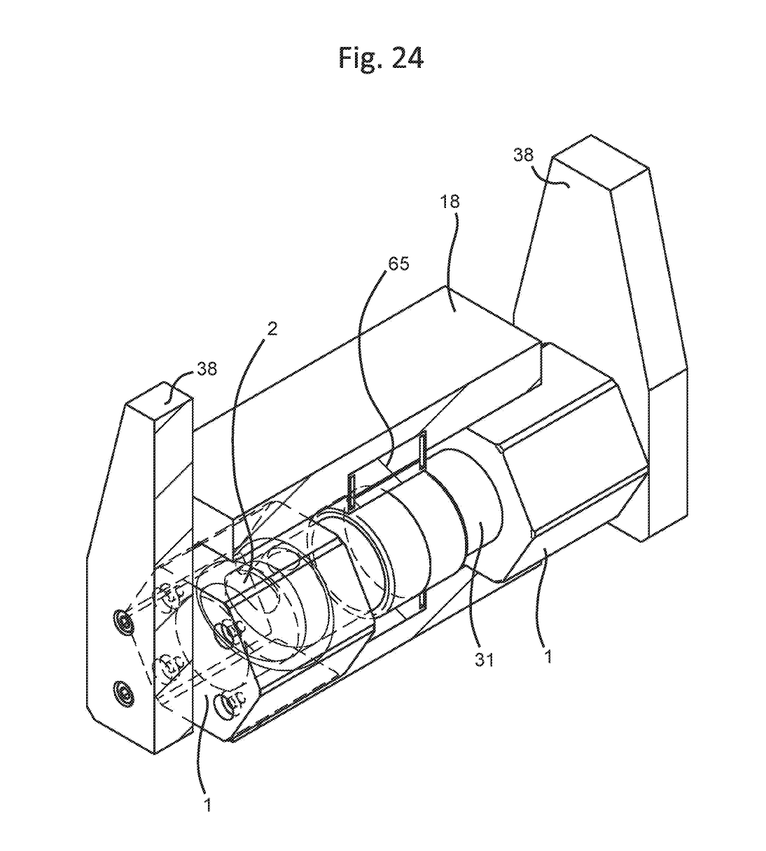

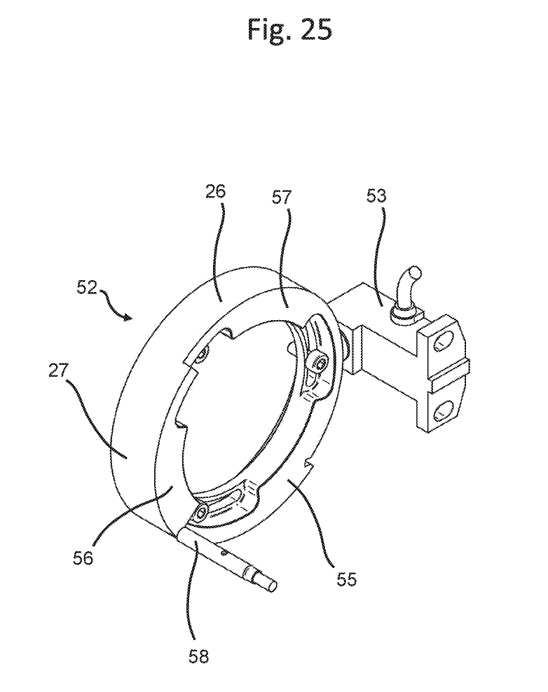

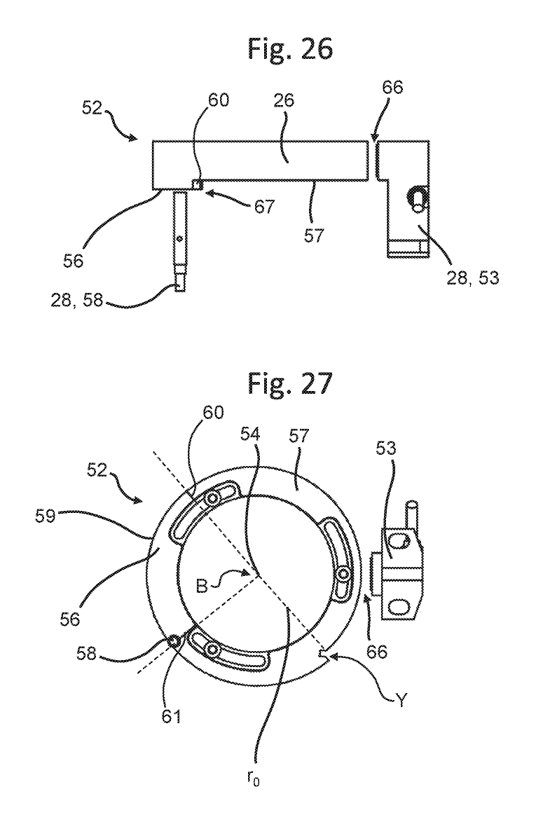

As shown clearly in FIGS. 22 and 24, the pull and/or push rod 1 has a rotationally symmetrical interior recess 43, in which an actuating element 31 engages which is at least indirectly non-rotatably connected with an electric motor 17. The two-piece shaped actuating element 31 has two control members 3, each of which engage in one of the cams 2 of the pull and/or push rods for axial adjustment of the pull and/or push rods 1 between a closed position or a clamping position (FIGS. 21 and 22), and an open position (FIGS. 23 and 24). The clamping position is preferably situated between the open position and the closed position. The closed position may alternatively also correspond to the clamping position.

In the present embodiment, two individual actuating elements 31 engaging in the respective hollow rods are provided, whereas the two individual actuating elements can also be integrally molded. This simplifies the transmission of the rotational movement from the electric motor 17, which in this case is formed as a torque motor 65, to the actuating elements 31. The pull and/or push rods 1 thereby essentially correspond to the pull and/or push rod 1 shown in FIGS. 7a to 7e. In order to store the pull and/or push rods 1 axially displaceable but rotationally fixed in the housing 18, these also have a non-circular outer contour, a polygon in the present example, in particular a hexagon. The cam 2 is formed with a first idle stroke section 9, which is followed by a coil section 8. At the other end of the coil section 8, a second idle stroke section 10 is arranged, which predetermines the final position (clamping position). If the centrally arranged torque motor 65 is actuated, it powers the actuating elements 31 with the control members 3. In this way, the control members 3 can be slidably switched within the cam 2, between the clamping position and the release position.

In an alternative embodiment, it is provided that one of the gripper arms 38 is formed as a fixed, i.e. fixed relative to the housing 18, gripper arm 38. The fixed gripper arm 38 cannot be operated with a pull and/or push rod. The at least one other not fixed gripper arm 38, however, can be operated by means of a pull and/or push rod 1 according to the present invention in order to switch the parallel gripper between a closed position and if necessary, a clamping position, and an open position.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A pull and/or push rod that is adjustable along a rod longitudinal axis, comprising a cam for guiding a control member having an at least partially spiral-shaped coil section having one or several slope portions.

2. The pull and/or push rod according to claim 1, wherein the cam comprises at least one idle stroke section adjoining the coil section and substantially extending radially to the rod longitudinal axis.

3. The pull and/or push rod according to claim 1, wherein the cam is formed on an outer periphery.

4. The pull and/or push rod according to claim 1, wherein the pull and/or push rod is at least partially formed as a hollow bar, and wherein the cam is formed in an inner periphery of a hollow rod.

5. The pull and/or push rod according to claim 1, further comprising an extension having a non-circular cross-section or an inner receptacle having a non-circular cross-section.

6. The pull and/or push rod according to claim 5, wherein, on a side facing away from the extension or from the inner receptacle, a rotatable cap and/or a thrust bearing is arranged.

7. An electrical release unit comprising:
a pull and/or push rod according to claim 1;
an electric motor, which is at least indirectly non-rotatably coupled with the pull and/or push rod; and
a control member that is at least axially fixed in a housing, and adapted to engage with the cam for the axial adjustment of the pull and/or push rod between a clamping position and a release position.

8. The electrical release unit according to claim 7, wherein the control member is formed as a control pin or as a control ball.

9. The electrical release unit according to claim 7, wherein the output of the electric motor is associated with an eccentric gear, which is at least indirectly non-rotatably coupled with the pull and/or push rod.

10. The electrical release unit according to claim 7, wherein a driving flange having an axially extending drive collar is connected to a drive spindle of the electric motor.

11. The electrical release unit according to claim 7, wherein a driving flange having a non-circular cross-section is associated with the drive collar for rotationally driving the pull and/or push rod.

12. The electrical release unit according to claim 7, wherein the drive collar is rotationally fixed to a sensor sleeve having a sensor target that is eccentrically disposed relative to the rod longitudinal axis or is formed with a peripheral slope.

13. The electrical release unit according to claim 12, wherein a distance sensor is assigned to the sensor target, wherein the distance of the distance sensor to the sensor target is formed proportionally to the axial position of the pull and/or push rod within the housing.

14. The electrical release unit according to claim 7, wherein, in the housing, a slide bearing and/or a slide bush is arranged coaxially to the rod longitudinal axis.

15. An electrical separating device comprising:
a pull and/or push rod according to claim 1, which is guided rotationally fixed but axially displaceably in a housing and is connected with a separating finger;
an electric motor that is at least indirectly non-rotatably coupled with an actuating element; and
a control member arranged at the actuating element that engages in the cam for the axial adjustment of the pull and/or push rod between a separating position and an open position.

16. The electrical separating device according to claim 15, wherein, in the pull and/or push rod, a resilient element is arranged to damp forces acting axially on the separating finger.

17. An electrical gripping device comprising:
gripper base jaws that are radially adjustable to the gripper longitudinal axis and are guided in gripper grooves, which interact over splines extending tilted to the gripper longitudinal axis with an axially adjustable wedge hook or wedge cone, which is connected to a pull and/or push rod according to claim 1;
an electric motor that is at least indirectly non-rotatably coupled to an actuating element; and
a control member arranged at the actuating element, which engages in the cam for the axial adjustment of the pull and/or push rod between a closed position and an open position.

18. The electrical gripping device according to claim 17, wherein, in the pull and/or push rod, a resilient element is arranged to damp forces radially acting on the gripper base jaws.

19. The electrical gripping device of claim 17, wherein the top jaws are provided for releasable attachment to the gripper base jaws, which are equipped with radially inner gripper surfaces for an external gripping of workpieces and/or with radially outer gripper surfaces for an internal gripping of workpieces.

20. An Electrical parallel gripping device comprising:
at least two gripper arms, of which at least one can be actuated with a pull and/or push rod according to claim 1;
an electric motor, which is at least indirectly non-rotatably coupled with an actuating element; and
a control member arranged at the actuating element, which engages in the cam of the pull and/or push rod for axial displacement between a closed position and an open position.
